(19) United States
(12) Patent Application Publication
(10) Pub. No.: US 2007/0275588 A1
(43) Pub. Date: Nov. 29, 2007

(54) ISOLATED SIGNAL PROBE

(75) Inventors: Edward J. Bodette, Cary, NC (US); Michael H. Crowder, Cary, NC (US); Rudolf E. Rehquate, Raleigh, NC (US); Carl D. Susinno, Raleigh, NC (US)

Correspondence Address: CAREY, RODRIGUEZ, GREENBERG & PAUL, LLP;STEVEN M. GREENBERG, 950 PENINSULA CORPORATE CIRCLE, SUITE 3020, BOCA RATON, FL, 33487, US

(73) Assignee: International Business Machines Corporation, Armonk, NY (US)

(21) Appl. No.: 11/420,775

(22) Filed: May 29, 2006

(51) Int. Cl. H01R 13/625

(52) U.S. Cl. 439/341

(57) ABSTRACT

An isolated signal probe comprises an input module, an output module, and a fiber optic line connecting the input module to the output module. The input module includes external positive and negative terminals, an input translation circuit electrically connected to the external positive and negative terminals, a first power supply for driving the input translation circuit, and an electrical-to-optical converter that receives a first signal from the input translation circuit. The output module includes an optical-to-electrical converter, an output translation circuit for receiving a second signal from the optical-to-electrical converter; a second power source for driving the output translation circuit, and an output connector electrically connected to the output translation circuit. The fiber optic line connects the electrical-to-optical converter to the optical-to-electrical converter.

### BACKGROUND OF THE INVENTION

1. Field of the Invention

The disclosure relates generally to electric testing equipment and, more specifically, to a testing device for measuring an electrical characteristic of a circuit.

2. Description of the Related Art

To meet certain regulatory requirements, electrical equipment is typically tested to determine its electromagnetic compatibility, one aspect of which is an evaluation of the equipment's ability to withstand electrostatic discharges without failing. During the test, the electrical equipment is subjected to an electrostatic discharge, typically having a peak voltage in excess of 6000 Volts and several amps of current. In those instances where the equipment is unable to withstand the electrostatic discharge, additional testing may be performed to determine what component(s) within the electrical device failed as a result of the electrostatic discharge.

To determine what component failed during the test, an electrical measurement is taken across portions of the electrical circuit within the electrical device. This electrical measurement involves using measurement probes to determine a voltage drop across the portion of the electrical circuit while the test is being performed. An issue arising with this type of test is that noise from the electrostatic discharge may couple capacitively and inductively to the measurement probe to create false electrical readings. Thus, current testing procedures mimics a basic principle of quantum physics, which is that the act of observing something happening causes a change in the thing being observed.

In normal testing conditions, this issue could be minimized by controlling the environment in which the measurements are taking place to reduce sources of electromagnetic noise. However, where the circuit under test is being evaluated for its sensitivity to electrostatic discharge, the presence of electromagnetic noise is a byproduct of the necessary electrostatic discharge needed to illicit the desired sensitivity response from the circuit. There is, therefore, a need for a testing device that is capable of measuring electrical properties of a circuit under test while minimizing the effect on the circuit of the measurement.

### BRIEF SUMMARY OF THE INVENTION

Embodiments of the invention address deficiencies of the art in respect to measurement devices and provide a novel and non-obvious isolated signal probe. The isolated signal probe comprises an input module, an output module, and a fiber optic line connecting the input module to the output module. The input module includes external positive and negative terminals, an input translation circuit electrically connected to the external positive and negative terminals, a first power supply for driving the input translation circuit, and an electrical-to-optical converter that receives a first signal from the input translation circuit. The output module includes an optical-to-electrical converter, an output translation circuit for receiving a second signal from the optical-to-electrical converter; a second power source for driving the output translation circuit, and an output connector electrically connected to the output translation circuit.

The fiber optic line connects the electrical-to-optical converter to the optical-to-electrical converter. The input translation circuit converts a differential voltage of an input from the positive and negative terminals into a current for driving the electrical-to-optical converter. The output translation circuit converts a current from the optical-to-electrical converter into a voltage to be outputted by the output connector. By isolating the input module from the output module via a fiber optic line, distortion of the electrical characteristics, by the signal probe, of a circuit being tested is reduced.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a perspective view of an isolated signal probe in accordance with the inventive arrangements; and

FIG. 2 is a system diagram of the isolated signal probe being used to test a circuit.

### DETAILED DESCRIPTION OF THE INVENTION

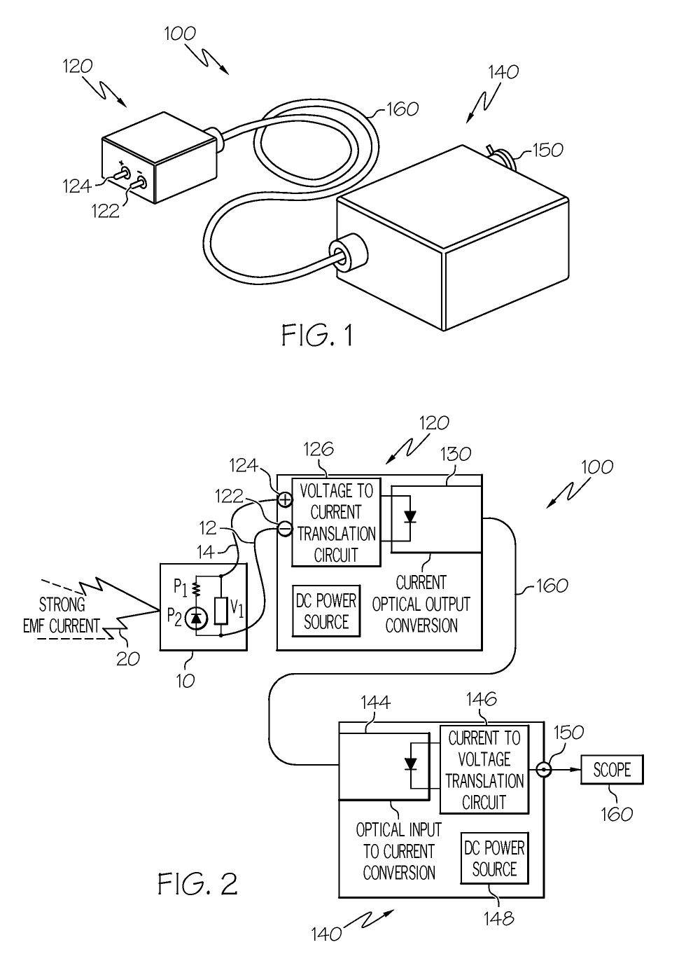

FIGS. 1 and 2 illustrate an isolated signal probe 100 for measuring electrical properties of a circuit 10 under test. The signal probe 100 includes an input module 120, an output module 140, and a fiber optic line 160 connecting the input module 120 to the output module 140. Although not limited in this manner, the signal probe 100 may be used to test the circuit 10 while the circuit 10 is experiencing a strong EMF event 20. The input module 120 includes external negative and positive probes 122, 124 that are electrically connected to the circuit 10 either directly or indirectly using, for example, probe leads 12, 14.

The input module 120 may include an input translation circuit 126, a first power supply 128, and an electrical-to-optical (E/O) converter 130. The input translation circuit 126 is electrically connected to the external negative and positive terminals 122, 124 and is used to measure an electrical characteristic of the circuit 10. For example, the input translation circuit 126 may be a voltmeter, an ammeter, or an ohmmeter. No matter the particular electrical characteristic of the circuit 10 being measured, other electrical characteristics of the circuit 10 can be inferred using, for example, Ohm's law. In certain aspects of the signal probe 100, however, the input translation circuit 126 measures a differential voltage V_{I} and converts the differential voltage V_{I} into a first electrical signal having a current I_{IM}.

The first power supply 128 drives the input translation circuit 126, and the first power supply 128 is not limited as to a particular type of power supply. For example, the first power supply 128 may be a parasitic power supply. However, in certain aspects of the signal probe 100, the first power supply 128 is an isolated DC power supply.

The E/O converter 130 converts the first electrical signal from the input translation circuit 126 into a light signal, which is then input into the fiber optic line 160. Many types of E/O converters 130 are known, and the signal probe 100 is not limited as to a particular type of E/O converter 130. Examples of acceptable E/O converters 130 include a light-emitting diode (LED) and a laser diode.

These types of E/O converters 130, however, have differing characteristics. For example, the output of an LED is linearly proportional to the drive current, whereas the output of a laser diode is proportional to current above a threshold current, which typically between about 5 to about 40 mA. Also, other differences include that a LED has a wider spectral width than a laser diode, whereas the output optical beam divergence is higher with a LED and lower with a laser diode.

The fiber optic line 160 is essentially immune to electromagnetic noise. As a result, the light signals being sent from the input module 120 to the output module 140 are not affected by the extreme electromagnetic environment created by the strong EMF event 20 while the circuit 10 is under test.

The output module 140 may include an optical-to-electrical (O/E) converter 144, an output translation circuit 146, and a second power supply 148. After passing through the fiber optic line 160, the optical signal is received by the O/E converter 144, which converts the optical signal into a second electrical signal. Many types of O/E converters 144 are known, and the signal probe 100 is not limited as to a particular type of E/O converter 144.

The output translation circuit 146 receives the second electrical signal from the O/E converter 144 and translates the second electrical signal into a desired output that is reflective of the electrical characteristic of the circuit 10 being measured. The desired output is then transmitted via the connector 150 to a standard measurement device, such as an electronic oscilloscope 160. The desired output is not limited as to a particular electric characteristic. Also, the transfer characteristics, V_{I} to V_{O}, of the signal probe 100 may be adjusted such that the signal V_{O} measured on the scope 160 directly corresponds to the voltage V_{I} being measured at the circuit 10.

The second power supply 148 drives the output translation circuit 146, and the second power supply 148 is not limited as to a particular type of power supply. For example, the second power supply 148 may be a parasitic power supply. However, in certain aspects of the signal probe 100, the second power supply 148 is an isolated DC power supply.

The signal being generated by the output module 140 may be controlled and/or modified, for example, using amplifier gain or scaling, signal synchronization, power control or through the use of other programmable parameters. This control or modification of the signal may take place within the output module 140 or after the signal is outputted via the output connector 150 using, for example, the scope 160 or any other device so capable.

What is claimed is:

1. An isolated signal probe, comprising:
an input module including an electrical-to-optical converter;
an output module including an optical-to-electrical converter; and
a fiber optic line connecting the electrical-to-optical converter to the optical-to-electrical converter.

2. The signal probe of claim 1, wherein the input module includes an input translation circuit for transmitting a first signal to the electrical-to-optical converter.

3. The signal probe of claim 2, wherein the input module includes a first power source for driving the input translation circuit.

4. The signal probe of claim 2, wherein the input module includes external positive and negative terminals electrically connected to the input translation circuit.

5. The signal probe of claim 4, wherein the input translation circuit converts a differential voltage of an input from the positive and negative terminals into a current for driving the electrical-to-optical converter.

6. The signal probe of claim 1, wherein the output module includes an output translation circuit for receiving a second signal from the optical-to-electrical converter.

7. The signal probe of claim 6, wherein the output module includes a second power source for driving the output translation circuit.

8. The signal probe of claim 6, wherein the output module includes an output connector electrically connected to the output translation circuit.

9. The signal probe of claim 8, wherein the output translation circuit converts a current from the optical-to-electrical converter into a voltage to be outputted by the output connector.

10. An isolated signal probe, comprising:
an input module including
external positive and negative terminals,
an input translation circuit electrically connected to the external positive and negative terminals,
a first power supply for driving the input translation circuit, and
an electrical-to-optical converter receiving a first signal from the input translation circuit;
an output module including an optical-to-electrical converter; and
a fiber optic line connecting the electrical-to-optical converter to the optical-to-electrical converter.

11. The signal probe of claim 10, wherein the output module includes an output translation circuit for receiving a second signal from the optical-to-electrical converter.

12. The signal probe of claim 11, wherein the output module includes a second power source for driving the output translation circuit.

13. The signal probe of claim 11, wherein the output module includes an output connector electrically connected to the output translation circuit.

14. The signal probe of claim 13, wherein the output translation circuit converts a current from the optical-to-electrical converter into a voltage to be outputted by the output connector.

15. The signal probe of claim 10, wherein the input translation circuit converts a differential voltage of an input from the positive and negative terminals into a current for driving the electrical-to-optical converter.
